(19) United States
(12) Patent Application Publication
(10) Pub. No.: US 2017/0234440 A1
(43) Pub. Date: Aug. 17, 2017

(54) Control cylinder for a control valve and control valve comprising such a control cylinder

(71) Applicant: VAG - Armaturen GmbH, Mannheim (DE)

(72) Inventors: Andreas DETMERS, Heddesheim (DE); David MARKHEISER, Neustadt (DE); Carl SCHULZ, New Berlin, WI (US)

(73) Assignee: VAG - Armaturen GmbH, Mannheim (DE)

(21) Appl. No.: 15/428,352

(22) Filed: Feb. 9, 2017

(30) Foreign Application Priority Data
Feb. 17, 2016 (DE) 10 2016 102 756.1

(51) Int. Cl. F16K 3/34; F16K 47/04

(52) U.S. Cl. CPC F16K 3/34; F16K 47/04

(57) ABSTRACT

A control cylinder for a control valve, the control cylinder including a main body having through-openings. To optimize the flow and to reduce cavitation, the through-openings have an inside wall with a curved, oblique or conical profile and/or with edges and/or undercuts.

### FIELD OF THE INVENTION

The present invention relates to a control cylinder for a control valve. The present invention also relates to a control valve having such a control cylinder.

### BACKGROUND

DE 20 2012 003 033 U1 discloses a prior-art control valve configured in the form of a plunger valve, with a valve piston movably disposed within a housing and with a plurality of control cylinders disposed within a throttling region of the housing. To be able to adjust the control characteristics and to avoid cavitation phenomena, the concentric control cylinders comprise through-openings distributed along the circumference. In the prior-art control cylinders, the through-openings are, as a rule, configured in the form of round, square or slotted holes with a straight profile and a constant cross section over the entire length.

### SUMMARY

At least some embodiments of the disclosure relate to a control cylinder for a control valve and a control valve having at least one such control cylinder, which control cylinder and control valve make it possible to further optimize the flow and reduce cavitation.

Useful embodiments and advanced further refinements of the invention are also disclosed.

In the control cylinder of a control valve according to the present invention, the through-openings have an inside wall with a curved, oblique or conical profile and/or with edges and/or undercuts. As a result, it is possible to create a plurality of complexly shaped through-openings that make it possible to optimize the flow and to avoid cavitation. The through-openings may, e.g., have a changing cross section and/or extend through the main body in the form of spirals, steps, curves or zigzags.

According to one possible embodiment, the inside wall of the through-openings can have a profile that is curved toward or away from a center line of the through-openings. The through-openings can be configured, e.g., in the form of a venturi nozzle with a cross section which, when looking in the flow direction, initially narrows and subsequently widens again. However, the through-openings can also have a plurality of consecutive conical sections or a plurality of cylindrical sections laterally offset relative to each other.

The through-openings preferably have a single passageway. However, the through-openings may also comprise molded parts for further dividing the flow.

According to another possible embodiment, the through-openings can have differently shaped inlet openings on an outside face and outlet openings on an inside face of the main body. The inlet openings can be configured, e.g., in the shape of a slotted hole, and the outlet openings can be configured in the shape of a circular hole. Likewise, the inlet openings can also be configured in the shape of a circular hole and the outlet opening can be configured in the shape of a slotted hole. However, the inlet and outlet openings may also have any other shapes.

A control cylinder with the above-described through-openings can be produced by means of a 3D printing process in which layers of metal powder are deposited on a surface and a laser beam is used to selectively melt these layers. The laser beam melts the metal powder layer by layer in the areas which subsequently are to be filled with material. This allows the production of control cylinders with through-openings of any shape from [sic; in] a single piece.

In addition, the present invention also relates to a control valve with at least one above-described control cylinder.

### BRIEF DESCRIPTION OF THE DRAWINGS

Additional special features and advantages of the present invention follow from the description of a preferred embodiment example below with reference to the drawing. The drawing shows:

FIG. 1 a longitudinal section through a control valve configured in the form of a control cylinder;

FIG. 2 a longitudinal section through a control cylinder with variable through-openings;

FIG. 3 a longitudinal section through a control cylinder with other through-openings;

FIG. 4 a sectional view of other practical examples of through-openings in a main body of a control cylinder;

FIG. 5 a top view of the through-openings shown in FIG. 4, and

FIG. 6 a bottom view of the through-openings shown in FIG. 5.

### DETAILED DESCRIPTION

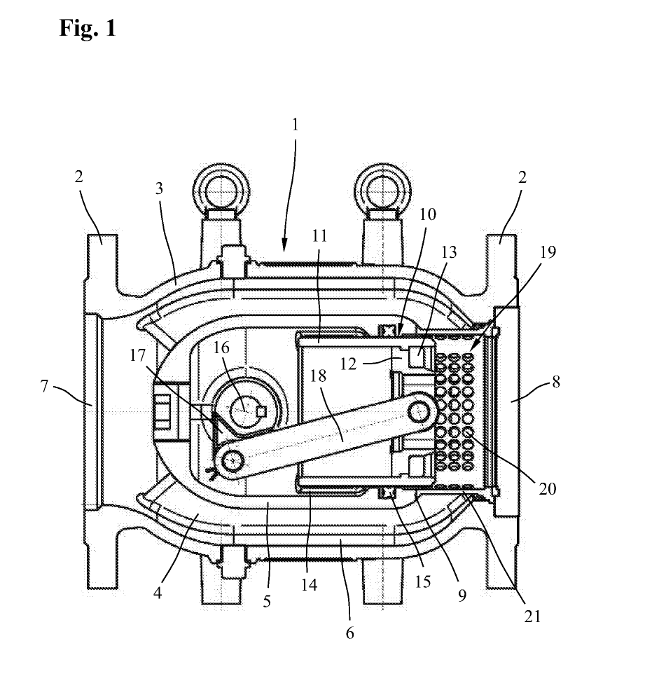

FIG. 1 shows a longitudinal section through a control valve, here configured in the form of a plunger valve, for controlling the mass flow rate of water or for controlling the water pressure in water supply lines. The plunger valve shown preferably comprises a housing 1 made of ductile cast iron which comprises an external section 3 having connecting flanges 2 and an internal body 5 supported against the inside of the external section 3 by retaining ribs 4. Located between the external section 3 and the internal body 5 of the housing 1 is an annular channel 6, through which water or another medium can flow from an inlet end 7 to an outlet end 8 of the housing 1.

The internal body 5, which is closed toward the inlet end 7 where it has a spherical shape, has an opening 9 oriented toward the outlet end 8. In the internal body 5 of the housing 1, which is open toward the outlet end 8, a valve body 10, here configured in the form of a shut-off plunger, is free to move in an axial direction. Through the axial movement of the plunger-shaped valve body 10, it is possible to control the passage through the annular channel 6. In the embodiment shown in the figure, the plunger-shaped valve body 10 comprises a shut-off sleeve 11, a connecting rod bearing 12 and a retaining ring 13 for attaching the connecting rod bearing 12 to the shut-off sleeve 11. Inside the internal body 5, the shut-off sleeve 11 is free to move in an axial direction on internal guide rails 14 and is radially sealed against the internal body 5 by means of a seal 15, here configured in the form of a four-lobed seal (Quad ring).

In its longitudinal movement, the valve body 10 is driven by a crank mechanism by means of a drive crank 17 mounted on a drive shaft 16 and a connecting rod 18 which is hinged to the drive crank 17 and the connecting rod bearing 12. Turning the drive shaft 16 allows the plunger-shaped valve body 10 to be moved between an open position, as shown in FIG. 1, and a closed position shifted to the right.

In addition, also disposed inside the housing 1 is a control cylinder 19 oriented coaxially with respect to the valve body 10, which control cylinder comprises a hollow cylindrical main body 21 having a plurality of through-openings 20. By means of differently arranged and differently designed control cylinders 19 with through-openings 20 of different shapes and configurations, it is possible to change the control characteristics of the control valve and to adapt them to the intended use. In addition, by suitably selecting the control cylinders 19, cavitation phenomena can be avoided. In the embodiment shown in the drawing, the control cylinder 19 is immovably disposed on the housing 1 between the opening 9 of the internal body 5 and the outlet end 8 of the housing 1. The inside diameter of the control cylinder 19 is slightly larger than the outside diameter of the shut-off sleeve 11. As a result, the shut-off sleeve 11 of the valve body 10 can be moved inside the control cylinder 19. According to another embodiment, however, the control cylinder 19 can also be disposed on the valve body 10 or it can be configured so as to be part of the valve body 10 and be moved together with the valve body. It is also possible for a plurality of control cylinders 19 oriented coaxially with respect to each other to be disposed inside the housing 1.

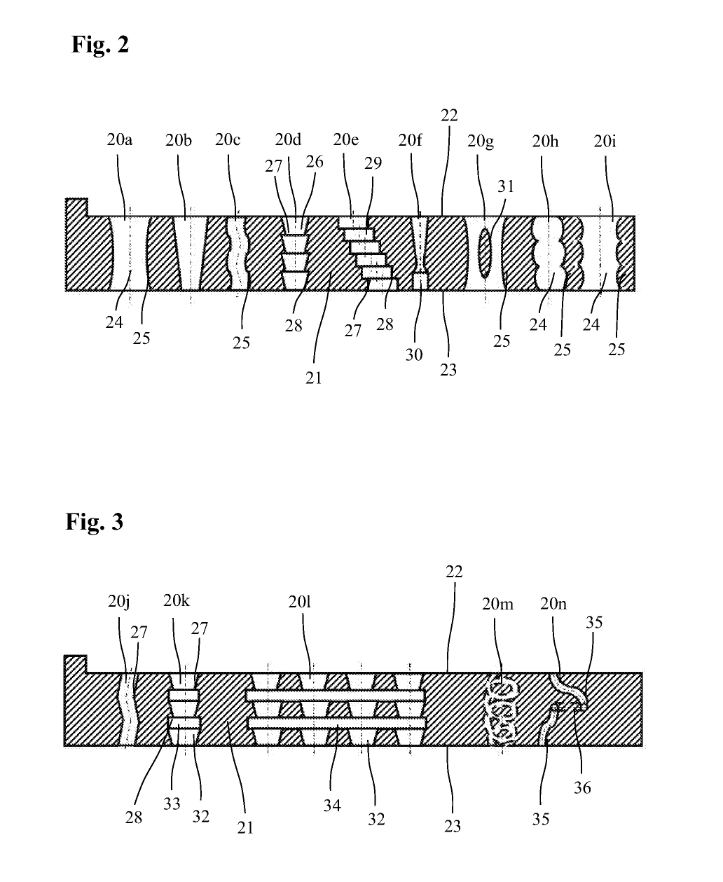

FIG. 2 shows different embodiment examples of the through-openings 20a to 20i provided in a control cylinder 19, which extend from an outside face 22 to an inside face 23 of a hollow cylindrical main body 21. The through-opening 20a on the left side of FIG. 2, e.g., is configured in the form of a venturi nozzle with a cross section which, when looking in the direction of flow, initially narrows and subsequently widens again. An inside wall 25 of this through-opening 20a has a profile which curves toward the center line 24 of the through-opening 20a.

The through-opening 20b has a conical shape and its cross section decreases from the outside face 22 toward the inside face 23. In contrast, the through-opening 20c has a curvilinear shape and a curvilinear inside wall 25. The through-opening 20d comprises a plurality of consecutive conical sections 26 with inwardly oriented edges 27 and undercuts 28 in the transitional areas. The through-opening 20e comprises a plurality of cylindrical sections 29 in the form of steps laterally offset relative to each other with edges 27 and undercuts 28. The through-opening 20f is configured in the form of a venturi nozzle with a cross section which initially narrows from the outside face 22 toward the inside face 23 and subsequently widens again. The area 30 of the through-opening 20f facing the outside face 22 has a cylindrical shape. A through-opening 20g which is also configured in the form of a venturi nozzle has an inside wall 25 identical to that of the through-opening 20a and comprises an additional molded part 31 in its inside. The through-opening 20h has an inside wall 25 with multiple outwardly curved sections, i.e., sections curved away from the center line 24, while the inside wall 25 of the through-opening 20i has multiple sections curved inwardly in the direction of the center line 24 so as to form a multiple venturi nozzle.

FIG. 3 shows a cross section through a hollow cylindrical main body 21 of a control cylinder 19 with additional differently shaped through-openings 20j to 20n. The through-opening 20j, e.g., has a zigzag profile with inwardly projecting edges 27. In the through-opening 20k, plural consecutive conical sections 32 are separated from each other by cylindrical sections 33. Again, inwardly projecting edges 27 and undercuts 28 are present in the transition from the conical section 32 to the cylindrical section 33. Another possibility is to arrange plural through-openings 201 with consecutive conical sections 32 side by side, with plurality conical sections arranged side by side in the transitional zone being connected to each other by means of a jointly shared connecting section 34. The through-opening 20m has a helical or spiral-shaped profile. In addition to two sections 34 curved in a horizontal plane, the through-opening 20n also has one connecting section 35 curved in a horizontal plane.

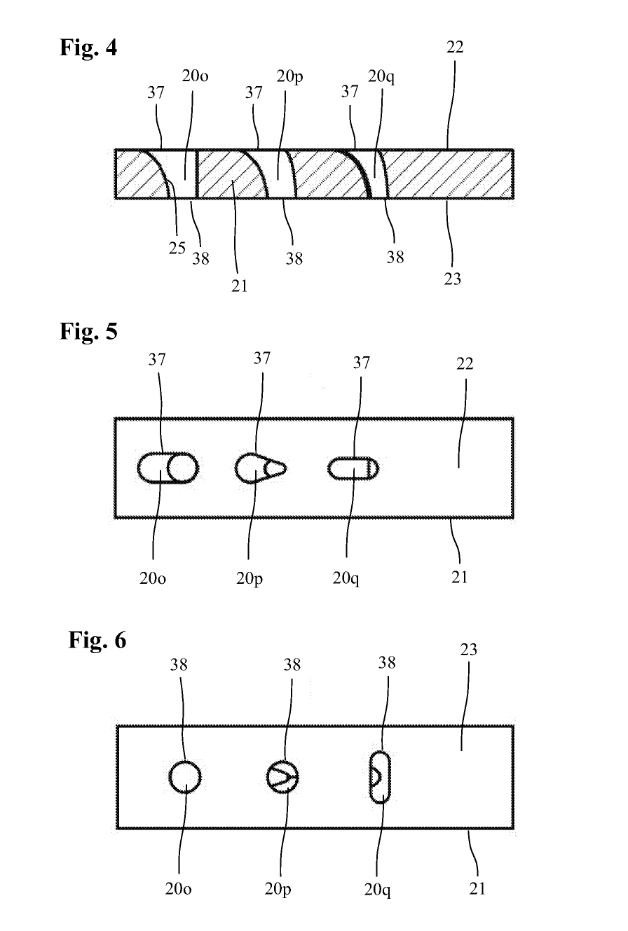

FIG. 4 shows three additional examples of through-openings 20o to 20q in a main body 21 of a control cylinder 19. The through-openings 20o to 20q, each of which has a curved inside wall 24, have inlet openings 37 on the outside face 22, a top view of which is shown in FIG. 5, the shape of which differs from that of the outlet openings 38 on the inside face 23 of the main body 21, a bottom view of which inside face is shown in FIG. 6. On the outside face 22 of the through-opening 20o, e.g., the inlet opening 37 shown in FIG. 5 is a slotted hole extending in the longitudinal direction of the main body 21, and on the inside face 23, the outlet opening 38 shown in FIG. 6 has a circular cross section. On the outside face 22 of the through-opening 20p, the inlet opening 37 has an oval cross section, and on the inside face 23, the outlet opening 38 has a circular cross section. On the outside face 22 of the through-opening 20q, the inlet opening 37 shown in FIG. 5 is a slotted hole extending in the longitudinal direction of the main body 21, while the outlet opening 38 shown in FIG. 6 is configured in the form of a slotted hole which extends at right angles relative to the longitudinal direction of the main body 21.

The common feature of all through-openings 20a to 20q is that, due to the complex geometry, they cannot be manufactured by means of boring, milling, punching or other conventional metal cutting processes. The complex shapes, however, can be produced by means of a 3D printing process in which the desired structure is built up layer by layer. To this end, a first layer of metal powder is deposited on a surface. Using a laser, the metal powder is then selectively melted in the areas which are later to be filled with material. Another layer of metal powder is subsequently added, and the procedure is repeated until the desired shape with the desired through-openings has been constructed. Thus, nearly any shape can be built up layer by layer, and a control cylinder with complexly shaped through-bores can be produced in a single piece.

What is claimed is:

1. A control cylinder for a control valve comprising a main body with through-openings, wherein the through-openings have an inside wall with a curved, oblique or conical profile and/or with edges and/or undercuts.

2. The control cylinder as in claim 1, wherein the through-openings extend through the main body in the form of spirals, steps, curves or zigzags.

3. The control cylinder as in claim 1, wherein the inside wall of the through-openings is curved toward or away from a center line of the through-openings.

4. The control cylinder as in claim 1, wherein the through-openings are configured in the form of a venturi nozzle with a cross section which, when looking in the direction of flow, initially narrows and subsequently widens again.

5. The control cylinder as in claim 1, wherein the through-openings comprise a plurality of consecutive conical sections or a plurality of cylindrical sections laterally offset relative to each other.

6. The control cylinder as in claim 1, wherein at least one molded part is deposed in the through-openings.

7. The control cylinder as in claim 1, wherein the through-openings have inlet openings on an outside face, the shape of which differs from that of outlet openings on an inside face of the main body.

8. The control cylinder as in claim 7, wherein the inlet openings are configured in the form of a slotted hole, and in that the outlet openings are configured in the form of a circular hole.

9. The control cylinder as in claim 7, wherein the inlet openings are configured in the form of a circular hole, and in that the outlet openings are configured in the form of a slotted hole.

10. The control cylinder as in claim 1, wherein the control cylinder is produced by means of a 3D printing process from layers of metal powder that are selectively melted layer by layer by a laser beam.

11. A control valve comprising a housing, a valve body adjustably disposed inside the housing and a first control cylinder disposed in the housing, wherein the first control cylinder is the control cylinder of claim 1.

12. The control valve as in claim 11, further comprising a second control cylinder, the first and second control cylinders oriented coaxially with respect to each other, wherein the second control cylinder is the control cylinder of claim 1.
